(19) United States
(12) Patent Application Publication
(10) Pub. No.: US 2026/0070505 A1
(43) Pub. Date: Mar. 12, 2026

(54) IMPACT MITIGATION DEVICE AND VEHICLE

(71) Applicant: DAICEL CORPORATION, Osaka (JP)

(72) Inventor: Masayuki NAKAYASU, Tokyo (JP)

(73) Assignee: DAICEL CORPORATION, Osaka (JP)

(21) Appl. No.: 19/393,618

(22) Filed: Nov. 19, 2025

Related U.S. Application Data
(63) Continuation of application No. PCT/JP2024/018799, filed on May 22, 2024.

(30) Foreign Application Priority Data
May 23, 2023 (JP) 2023-084421

(51) Int. Cl. B60R 21/04; B60R 21/00; B60R 21/01; B60R 21/013

(52) U.S. Cl. CPC B60R 21/04; B60R 21/013; B60R 2021/0006; B60R 2021/01286; B60R 2021/0421; B60R 2021/0442

(57) ABSTRACT

An impact mitigation device includes: an impact absorber configured to transition from a folded state in which the impact absorber is folded to an expanded state in which the impact absorber is expanded; a first magnetic body provided on one end side of the impact absorber; a second magnetic body provided on another end side of the impact absorber and at a position facing the first magnetic body in the folded state; and a control unit connected to one of the first magnetic body and the second magnetic body, the control unit being configured to control the one magnetic body to generate a repulsive force between the one magnetic body and the other magnetic body.

### CROSS-REFERENCE TO RELATED APPLICATIONS

This application is a bypass continuation application of international application No. PCT/JP2024/018799, filed on May 22, 2024, which claims the benefit of priority from Japanese Patent Application No. 2023-084421, filed on May 23, 2023, the entire contents of each are incorporated herein by reference.

### TECHNICAL FIELD

The present invention relates to an impact mitigation device and a vehicle.

### BACKGROUND ART

In the related art, an airbag device for a side collision of an automobile has been proposed (for example, Patent Document 1). In this device, since the rear end of the partition wall is positioned within the vertical dimension range of the inflator and the communication portion is formed by separating the rear end of the partition wall and the inflator from each other, the shape of the rear end portion of the airbag is three-dimensionally maintained by the inflator, and the communication portion is ensured to be opened to some extent from the beginning, thus the gas is easily supplied from the communication portion to the chest protection chamber, and the inflation speed of the entire airbag is improved.

### CITATION LIST

### Patent Document

Patent Document 1: JP 2003-182499 A

### SUMMARY OF INVENTION

### Technical Problem

An object of the technique of the present disclosure is to provide a novel technique for protecting a user.

### Solution to Problem

The present disclosure solves the above problems by the following aspects. That is, the gist of the technology according to the present disclosure is as follows.
Aspect 1

An impact mitigation device including:
an impact absorber capable of transitioning from a folded state in which the impact absorber is folded to an expanded state in which the impact absorber is expanded;
a first magnetic body provided on one end side of the impact absorber;
a second magnetic body provided on another end side of the impact absorber and at a position facing the first magnetic body in the folded state; and
a control unit connected to one of the first magnetic body and the second magnetic body, the control unit being configured to control the one magnetic body to generate a repulsive force between the one magnetic body and the other magnetic body.
Aspect 2

In the impact mitigation device according to Aspect 1,
the impact absorber may include a bellows-like structure or a structure in which tubular bodies are laterally juxtaposed.
Aspect 3

In the impact mitigation device according to Aspect 2,
the impact absorber may be expanded linearly.
Aspect 4

In the impact mitigation device according to Aspect 2,
the impact absorber may be expanded in a fan shape.
Aspect 5

The impact mitigation device according to any one of Aspects 1 to 4 may include
a sensor connected to the control unit, the sensor being configured to output, to the control unit, a signal indicating a result of sensing or predicting an impact or a signal for the control unit to sense or predict an impact.
Aspect 6

In the impact mitigation device according to any one of Aspects 1 to 5,
the one magnetic body may be an electromagnet including an iron core, and
the other magnetic body may be a permanent magnet.
Aspect 7

In the impact mitigation device according to Aspect 6,
in the folded state, the permanent magnet may be attracted to the iron core.
Aspect 8

In the impact mitigation device according to Aspect 6,
in the folded state, the control unit may be configured to control a polarity of the electromagnet such that the electromagnet and the permanent magnet are attracted to each other.
Aspect 9

In the impact mitigation device according to any one of Aspects 1 to 8,
the impact mitigation device may be mounted in a vicinity of a boundary between a ceiling portion and a side wall portion of a vehicle, and in the expanded state, the impact mitigation device may be expanded between an occupant and the side wall portion of the vehicle.
Aspect 10

The impact mitigation device according to Aspect 9 may be implemented as a vehicle mounted in the vicinity of a boundary between the ceiling portion and the side wall portion.

### Advantageous Effects of Invention

According to the present disclosure, it is possible to provide a novel technique for protecting a user.

### BRIEF DESCRIPTION OF DRAWINGS

FIG. 1 is a diagram for explaining an impact mitigation device installed in a vehicle.

FIG. 2 is a perspective view illustrating an example of the impact mitigation device.

FIG. 3 is a schematic diagram for explaining an example of an operation of the impact mitigation device.

FIG. 4 is a perspective view illustrating a modification of the impact mitigation device.

FIG. 5 is a schematic diagram for explaining the operation of the impact mitigation device according to the modification.

FIG. 6 is a perspective view illustrating the modification of the impact mitigation device.

### DESCRIPTION OF EMBODIMENTS

A protection device and an operation method thereof according to an embodiment of the present disclosure are described below with reference to the accompanying drawings. Note that each of the configurations, combinations thereof, and the like in the embodiments is an example, and various additions, omissions, substitutions, and other changes of the configurations may be made as appropriate without departing from the spirit of the present disclosure. The present disclosure is not limited by the embodiments and is limited only by the claims.

The impact mitigation device according to the present embodiment includes: an impact absorber capable of transitioning from a folded state in which the impact absorber is folded to an expanded state in which the impact absorber is expanded; a first magnetic body provided on one end side of the impact absorber; a second magnetic body provided on another end side of the impact absorber and at a position facing the first magnetic body in the folded state; and a control unit (control device) connected to one of the first magnetic body and the second magnetic body, the control unit being configured to change a polarity of the one magnetic body to generate a repulsive force between the one magnetic body and the other magnetic body.

The impact mitigation device can protect the user by expanding the folded impact absorber. In addition, it is possible to realize a novel impact mitigation device capable of expanding the impact absorber by repulsion of the magnetic body.

### Embodiment

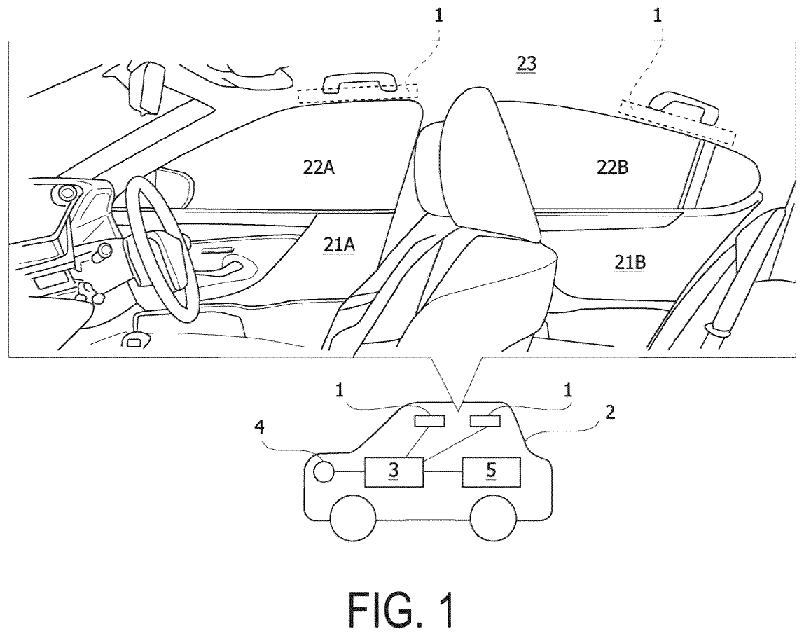

FIG. 1 is a diagram for explaining an impact mitigation device installed in a vehicle. An impact mitigation device 1 is mounted, for example, in the vicinity of a boundary between a side wall portion and a ceiling portion of a vehicle 2, and is expanded between the side wall portion and an occupant at the time of a collision of the vehicle 2. In addition, the impact mitigation device 1 includes an impact absorber, and mitigates an impact when the head of the occupant abuts against a structural portion of the vehicle, a component attached to the structural portion, or the like at the time of a collision of the vehicle 2. For example, the impact mitigation device 1 may be a part of a side door 21 (21A, 21B) and mounted above a window 22 (22A, 22B), or may be a part of a roof 23 and mounted in the vicinity of the side door 21. In addition to the impact mitigation device 1, the vehicle 2 includes a control device 3, a sensor 4, and a power supply 5. The control device 3 is a computer such as an electronic control unit (ECU). The control device 3 is connected to the power supply 5 that is a battery mounted on the vehicle 2, for example. That is, the control device 3 is supplied with power from the ignition power supply, the accessory power supply, or the constant power supply. In addition, the control device 3 detects or predicts a collision with the vehicle 2 based on a signal received from the sensor 4, and operates the impact mitigation device 1. The sensor 4 is, for example, an acceleration sensor, a radar, a light detection and ranging (LiDAR), a camera, or the like. The sensor 4 is also supplied with power from the power supply 5, and converts measured information into an electrical signal and outputs the electrical signal, or outputs captured image data.

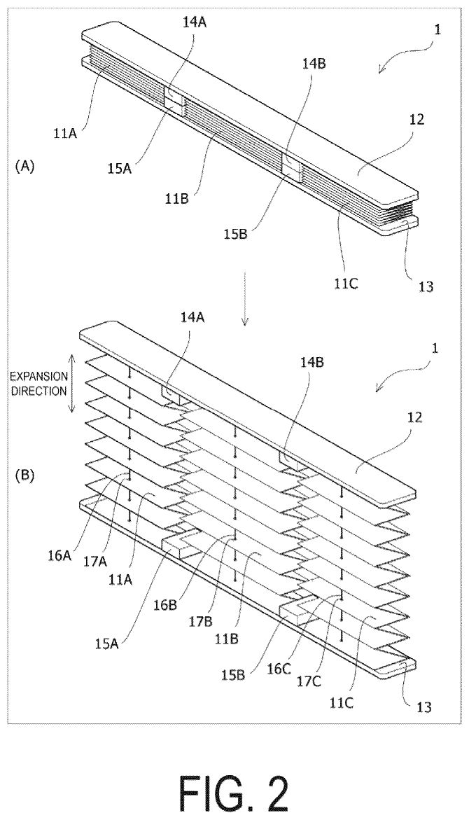

FIG. 2 is a perspective view illustrating an example of the impact mitigation device 1. FIG. 2(A) illustrates a folded state (also referred to as a first state) in which an impact absorber 11 is folded. FIG. 2(B) illustrates an expanded state (also referred to as a second state) in which the impact absorber 11 is expanded. The impact mitigation device 1 includes an impact absorber 11 (11A, 11B, 11C), a first end 12, a second end 13, a first magnetic body 14 (14A, 14B), a second magnetic body 15 (15A, 15B), and a restriction portion 16 (16A, 16B, 16C). In addition, the impact absorber 11 has a plurality of through holes 17 (17A, 17B, 17C) through which the string-shaped restriction portion 16 is inserted. The impact mitigation device 1 transitions from the folded state in which the impact absorber 11 is folded to the expanded state in which the first end 12 and the second end 13 are separated from each other and the impact absorber 11 is stretched in the expansion direction.

The impact absorber 11 is made of a material or a structure that absorbs an impact. For example, the impact absorber 11 may be formed of an elastic material such as silicone resin, natural rubber, and soft plastic. In addition, the impact absorber 11 may be formed to structurally absorb an impact, such as a foam material such as foamed polystyrene or foamed polyurethane, a resin sponge, a bubble cushioning material in which gas is sealed in a sheet, or a gel sheet in which gel is sealed in a sheet. In addition, the impact absorber 11 can transition between a folded state in which the impact absorber 11 is folded as illustrated in FIG. 1 and an expanded state in which the impact absorber 11 is expanded as illustrated in FIG. 2. The impact absorber 11 may have a structure in which a sheet-like member is folded in a bellows shape, for example. Then, the impact absorber 11 is expanded between the occupant and the vehicle 2, for example, at the time of collision of the vehicle 2, and is elastically deformed or plastically deformed by coming into contact with the occupant and the vehicle 2 to absorb the impact. In the example of FIG. 2(B), the impact absorber 11 is linearly expanded while the first end 12 and the second end 13 are substantially parallel to each other.

In the folded state, for example, as illustrated in FIG. 2(A), the impact absorber 11 is folded in a bellows shape. That is, the sheet-like impact absorber 11 has a repeated structure of mountain folds and valley folds. In the impact absorber 11, one end side in a continuous direction in which regions defined by the mountain folds and the valley folds are continuous is connected to the first end 12. The other end side in the continuous direction is connected to the second end 13. The first magnetic body 14 is connected to the first end 12, and the second magnetic body 15 is connected to the second end 13. In the example of FIG. 2, the impact mitigation device 1 includes three impact absorbers 11A, 11B, 11C. The first magnetic body 14A and the second magnetic body 15A are disposed between the impact absorber 11A and the impact absorber 11B, and the first magnetic body 14B and the second magnetic body 15B are disposed between the impact absorber 11B and the impact absorber 11C. However, the numbers of the impact absorbers 11, the first magnetic bodies 14, and the second magnetic bodies 15 are not limited to the example of FIG. 2. For example, the impact absorber 11 may be provided with a punched window portion in each of the regions partitioned by the folds to form a through hole in the folded state, and the first magnetic body 14 and the second magnetic body 15 may be disposed at a position corresponding to the through hole.

The first end 12 and the second end 13 reinforce an end portion on one end side and an end portion on the other end side of the impact absorber 11, respectively. The first end 12 holds the first magnetic body 14 on the one end side of the impact absorber 11. The first magnetic body 14 may be directly connected to the one end side of the impact absorber 11 without providing the first end 12. Further, the second end 13 holds the second magnetic body 15 on the other end side of the impact absorber 11. The second magnetic body 15 may be directly connected to the other end side of the impact absorber 11 without providing the second end 13. Further, the materials of the first end 12 and the second end 13 are not particularly limited.

The first magnetic body 14 is provided at an end portion on one end side of the impact absorber 11 via the first end 12. The second magnetic body 15 is provided at an end portion on the other end side of the impact absorber 11 via the second end 13. For example, one of the first magnetic body 14 and the second magnetic body 15 is an electromagnet, and the other is a permanent magnet. The electromagnet is formed by winding a coil around a magnetic material such as an iron core. Further, it is connected to the control device 3 illustrated in FIG. 1, and generates a magnetic force when the coil is energized. The permanent magnet may be, for example, a neodymium magnet, a ferrite magnet, an alnico magnet, or the like.

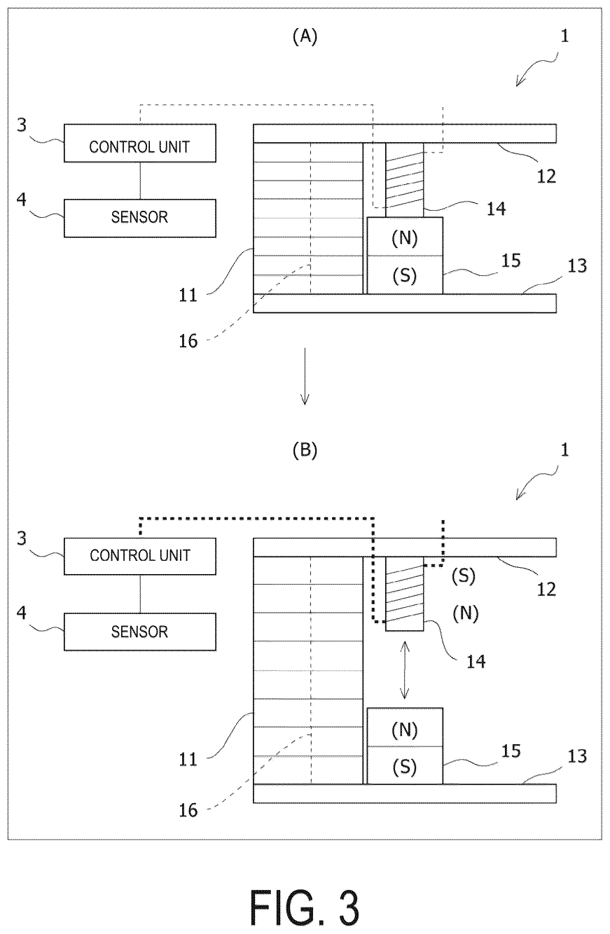

FIG. 3 is a schematic diagram for explaining an example of the operation of the impact mitigation device 1. FIG. 3(A) illustrates the impact mitigation device 1 in a folded state. FIG. 3(B) illustrates the impact mitigation device 1 in an expanded state. In the example of FIG. 3, the first magnetic body 14 is an electromagnet, and the second magnetic body 15 is a permanent magnet. In the folded state, the first magnetic body 14 is not supplied with power from the control device 3, for example, and the second magnetic body 15 is attracted to the core material of the first magnetic body 14. In addition, the control device 3 supplies power to the first magnetic body 14 according to the signal from the sensor 4, and magnetizes the first magnetic body 14 such that the opposing polarities of the first magnetic body 14 and the second magnetic body 15 become the same polarity. In the example of FIG. 3(B), the opposing polarity is the N pole. The polarities of the first magnetic body 14 and the second magnetic body 15 may be opposite to those in the example of FIG. 3. In the expanded state, the impact absorber 11 is expanded by a repulsive force generated between the first magnetic body 14 and the second magnetic body 15 as indicated by an arrow in FIG. 3(B). The impact absorber 11, which has started to expand, expands by gravity until the expansion is restricted by the restriction portion 16.

The restriction portion 16 is a string-shaped member and is formed of a predetermined fiber material, a metal wire, or the like. In addition, the restriction portion 16 passes through a plurality of through holes 17 provided in the impact absorber 11, one end side thereof is connected to the first end 12, and the other end side thereof is connected to the second end 13. The plurality of through holes 17 are provided at positions corresponding to each other in a plurality of regions defined by the folds of the impact absorber 11 to be substantially linear in the folded state. The length of the restriction portion 16 is shorter than the length in the above-described continuous direction when the impact absorber 11 is expanded in a planar shape. Therefore, the restriction portion 16 restricts the expansion of the impact absorber 11 to a predetermined length or more. That is, in the expanded state, the restriction portion 16 maintains the impact absorber 11 in a state of being mountain-folded and valley-folded at a predetermined degree of angle. Since the impact absorber 11 has the peak portions and the valley portions of the bellows structure even in the expanded state, the impact absorber 11 has a cushioning property while maintaining a certain degree of strength against a force applied in a direction in which the peak portions and the valley portions are crushed when the head of the occupant collides with the impact absorber 11. As described above, the impact absorber 11 absorbs an impact by its material and structure. The restriction portion 16 is folded together with the impact absorber 11 in the folded state.

The control device 3 illustrated in FIGS. 1 and 3 is, for example, an ECU including a micro controller. The control device 3 detects or predicts a collision with the vehicle 2 based on a signal received from the sensor 4, and operates the impact mitigation device 1. For example, when the control device 3 receives a signal indicating that an acceleration exceeding a predetermined threshold value is detected from the sensor 4 which is an acceleration sensor, the control device 3 operates the impact mitigation device 1. The control device 3 may receive image data from the sensor 4, which is a camera, and predict the possibility of collision on the basis of an existing analysis method. In this case, when the control device 3 determines that the possibility of the collision exceeds the predetermined threshold value, the control device 3 operates the impact mitigation device 1 at a stage before the collision occurs. Even when the sensor 4 is a radar, a LiDAR, or another sensor, the control device 3 can detect or predict a collision by an existing method.

The sensor 4 illustrated in FIGS. 1 and 3 is a device that continuously outputs, for example, data indicating a predetermined measurement value, image data, or the like. That is, the sensor 4 outputs a signal for the control device 3 to sense or predict an impact to the control device 3. The sensor 4 may be a sensor unit that detects or predicts a collision on the basis of data output from any sensor. That is, the sensor 4 may detect or predict a collision and output information indicating the result to the control device 3. In this case, the control device 3 controls the impact mitigation device 1 according to the information output by the sensor 4.

According to the impact mitigation device 1 as described above, an occupant can be protected particularly from a collision with a side surface of the vehicle 2. According to the configuration of driving by repulsion of magnetic force, it is not necessary to use a gas generator as in an airbag, for example. In this way, a compact and lightweight device for protecting an occupant can be provided.

### Modifications

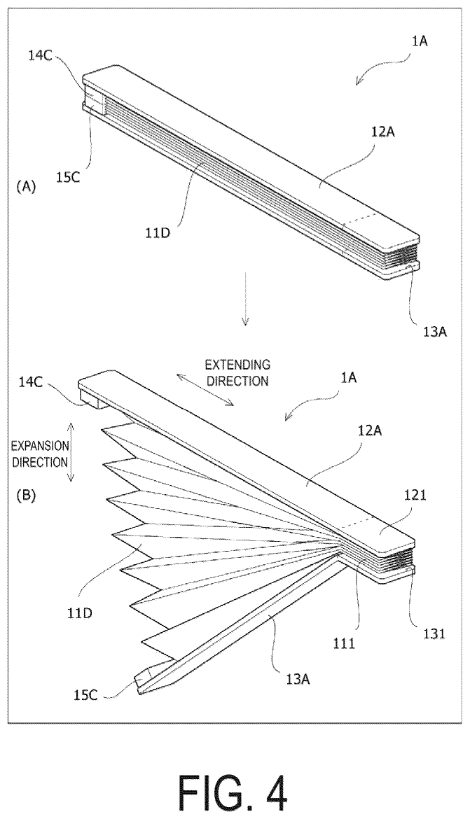

FIG. 4 is a perspective view illustrating a modification of an impact mitigation device 1A. FIG. 4(A) illustrates a folded state in which the impact absorber 11A is folded. FIG. 4(B) illustrates an expanded state in which the impact absorber 11A is expanded. The impact mitigation device 1A includes an impact absorber 11D, a first end 12A, a second end 13A, a first magnetic body 14C, and a second magnetic body 15C. Note that components corresponding to those of the above-described embodiment are denoted by corresponding reference numerals, and description thereof is omitted.

In the impact mitigation device 1A, the first magnetic body 14C and the second magnetic body 15C are disposed on one end side in an extending direction in which the first end 12A, the second end 13A, and the impact absorber 11D in the folded state extend. In addition, the impact absorber 11D includes, on the other end side in the extending direction, a bonding portion 111 in which the overlapping surfaces of the mountain-folded and valley-folded regions are bonded to each other. The bonding portion 111 is bonded to each of a bonding portion 121 of the first end 12A and a bonding portion 131 of the second end 13A. The bonding portion 111, the bonding portion 121, and the bonding portion 131 function as a restriction portion that suppresses the expansion of the impact absorber 11D.

In the expanded state, the opposing polarities of the first magnetic body 14C and the second magnetic body 15C provided on one end side in the extending direction of the impact absorber 11D are controlled to be the same polarity, and the impact absorber 11D is expanded by the repulsive force generated between the first magnetic body 14C and the second magnetic body 15C. The impact absorber 11D according to the present modification is expanded in a fan shape. That is, the second end 13A rotates about the bonding portion 131 and the impact absorber 11D is stretched such that the second magnetic body 15C draws an arc.

Also in the impact mitigation device 1A according to the modification, one end in the extending direction of the impact absorber 11D is fixed such that the impact absorber 11D is not expanded, whereby the peak portion and the valley portion of the bellows structure are maintained even in the expanded state. Therefore, when the head of the occupant collides with the impact absorber 11D, the strength against the force applied in the direction in which the mountain portion and the valley portion are crushed is improved. Also in this modification, a restriction portion may be provided such that the second end 13A is not expanded at a predetermined angle or more with respect to the bonding portion 131. For example, the restriction portion may be a string passing through the through hole 17 of the impact absorber 11 as illustrated in FIG. 2(B), or a stopper that collides with the second end 13A when expanded may be attached to the bonding portion 131.

### Modification of Magnetic Body

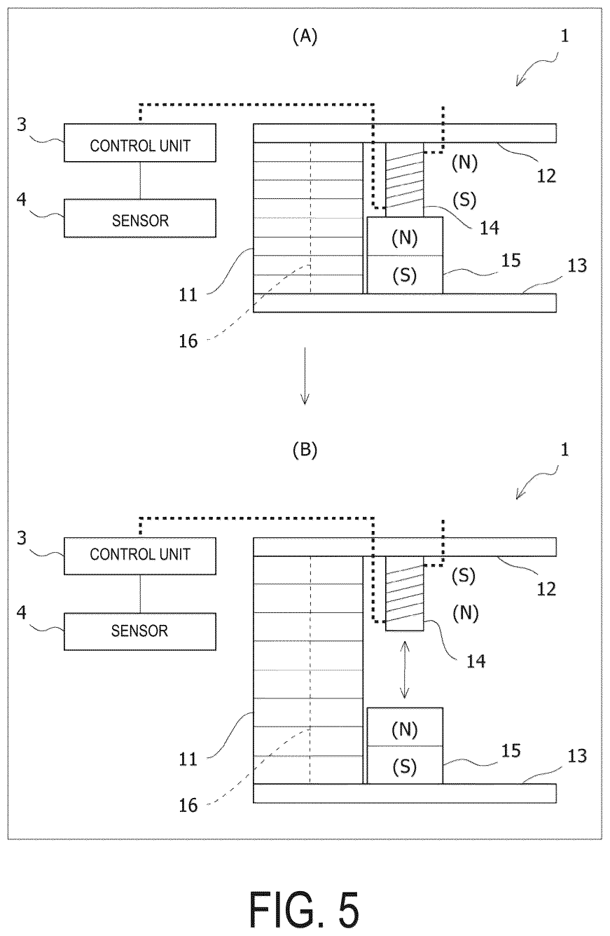

FIG. 5 is a schematic diagram for explaining the operation of the impact mitigation device 1 according to the modification. In the folded state, the first magnetic body 14 may be magnetized by power supply from the control device 3 such that the opposing polarities of the first magnetic body 14 and the second magnetic body 15 are different from each other. In the example of FIG. 5(A), the tip portion of the first magnetic body 14 is the S pole, and the tip portion of the second magnetic body 15 is the N pole. The first magnetic body 14 is supplied with power from, for example, an ignition power supply or an accessory power supply, and suppresses the impact absorber 11 from being expanded without depending on the control of the control device 3 due to shaking or the like during traveling of the vehicle 2. That is, in the present modification, the first magnetic body 14 and the second magnetic body 15 are more strongly attracted to each other by magnetizing the first magnetic body 14 such that the opposing polarities of the first magnetic body 14 and the second magnetic body 15 are different from each other.

The operation of expanding the impact mitigation device 1 is the same as that in the example of FIG. 3. The control device 3 reverses the direction of the current flowing through the coil of the first magnetic body 14 according to the signal from the sensor 4, and magnetizes the first magnetic body 14 such that the opposing polarities of the first magnetic body 14 and the second magnetic body 15 become the same polarity. In the example of FIG. 5(B), the opposing polarity is the N pole. The polarities of the first magnetic body 14 and the second magnetic body 15 may be reversed.

### Modification of Impact Absorber

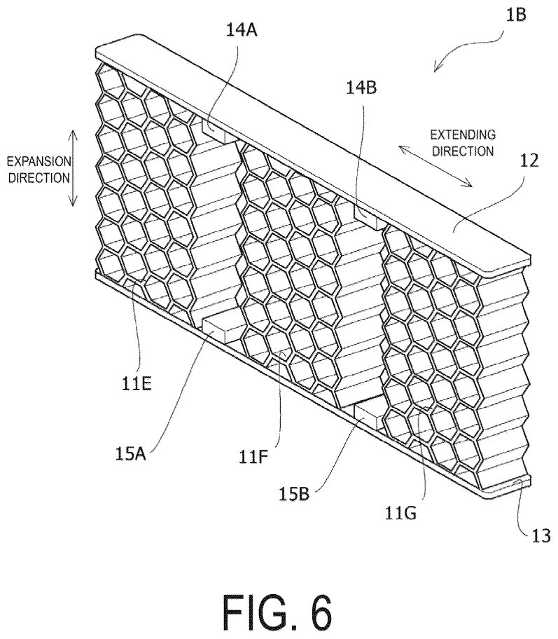

FIG. 6 is a perspective view illustrating a modification of the impact mitigation device. Note that components corresponding to those of the above-described embodiment are denoted by corresponding reference numerals, and description thereof is omitted. FIG. 6 illustrates an expanded state in which the impact absorber 11 is expanded. The impact mitigation device 1B includes the impact absorber 11 (11E, 11F, 11G), the first end 12, the second end 13, the first magnetic body 14 (14A, 14B), and the second magnetic body 15 (15A, 15B). The impact absorber 11 (11E, 11F, 11G) according to the present modification has a honeycomb structure. That is, in the expanded state, the impact absorber 11 has a plurality of substantially regular hexagonal through holes penetrating in a direction perpendicular to the expansion direction of the impact absorber 11 and the extending direction of the first end 12 and the second end 13. The impact absorber 11 may have a shape in which tubular bodies such as square tubular bodies or cylindrical bodies having a cross-sectional shape other than a regular hexagonal shape are juxtaposed (that is, such that through holes of the tubular bodies are substantially parallel to each other), and a gap may be provided between the tubular bodies juxtaposed. Further, the material of the impact absorber 11 may be rubber or elastomer having a shape memory effect. According to this modification, it is also possible to improve the strength of the impact absorber 11 in the direction in which the impact is applied when the head of the occupant collides with the impact absorber 11. However, the impact absorber 11 has a sufficient elastic force in a thickness direction thereof (that is, a direction in which the through hole penetrates), thereby mitigating the impact to the head of the occupant.

### Other

The embodiment of the present disclosure has been described above, and each of the aspects disclosed in the present specification can be combined with any other features disclosed therein. For example, the impact absorber 11 having a honeycomb structure may be expanded in a fan shape as illustrated in FIG. 4.

Alternatively, both the first magnetic body 14 and the second magnetic body 15 may be permanent magnets. In this case, a drive unit that rotates the posture of the one permanent magnet by 180 degrees such that the direction of the polarity of the one permanent magnet is reversed under the control of the control device 3 when the impact mitigation device 1 is operated is provided. Even in this case, a repulsive force is generated between one permanent magnet and the other permanent magnet, and the impact absorber 11 can be expanded.

In addition, the impact mitigation device 1 may be mounted on a portion other than the installation location of the vehicle 2 illustrated in FIG. 1 to protect the user, for example, by being expanded to the rear of the vehicle 2 to mitigate the impact of a rear-end collision, or by being expanded to the side opposite to the collision with respect to the user at the time of a side collision like a so-called far-side airbag. In addition, the impact mitigation device 1 may be mounted in a vehicle other than the vehicle 2, attraction equipment, or the like to protect a user.

### REFERENCE SIGNS LIST

1, 1A, 1B: Impact mitigation device
11 (11A to 11D): Impact absorber
12, 12A: First end
13, 13A: Second end
14 (14A to 14C): First magnetic body
15 (15A to 15C): Second magnetic body
16: Restriction portion
2: Vehicle
3 Control device
4: Sensor
5: Power supply

1. An impact mitigation device comprising:
an impact absorber configured to transition from a folded state in which the impact absorber is folded to an expanded state in which the impact absorber is expanded;
a first magnetic body provided on one end side of the impact absorber;
a second magnetic body provided on another end side of the impact absorber and at a position facing the first magnetic body in the folded state; and
a control unit connected to one of the first magnetic body and the second magnetic body, the control unit being configured to control the one magnetic body to generate a repulsive force between the one magnetic body and the other magnetic body.

2. The impact mitigation device according to claim 1, wherein
the impact absorber includes a bellows-like structure or a structure in which tubular bodies are laterally juxtaposed.

3. The impact mitigation device according to claim 2, wherein
the impact absorber is expanded linearly.

4. The impact mitigation device according to claim 2, wherein
the impact absorber is expanded in a fan shape.

5. The impact mitigation device according to claim 1, comprising:
a sensor connected to the control unit, the sensor being configured to output, to the control unit, a signal indicating a result of sensing or predicting an impact or a signal for the control unit to sense or predict an impact.

6. The impact mitigation device according to claim 1, wherein
the one magnetic body is an electromagnet including an iron core, and
the other magnetic body is a permanent magnet.

7. The impact mitigation device according to claim 6, wherein
in the folded state, the permanent magnet is attracted to the iron core.

8. The impact mitigation device according to claim 6, wherein
in the folded state, the control unit controls a polarity of the electromagnet such that the electromagnet and the permanent magnet are attracted to each other.

9. The impact mitigation device according to claim 1, wherein
the impact mitigation device is mounted in a vicinity of a boundary between a ceiling portion and a side wall portion of a vehicle, and in the expanded state, the impact mitigation device is expanded between an occupant and the side wall portion of the vehicle.

10. A vehicle, wherein
the impact mitigation device according to claim 9 is mounted in the vicinity of the boundary between the ceiling portion and the side wall portion.

11. An impact mitigation device comprising:
an impact absorber configured to transition from a folded state in which the impact absorber is folded to an expanded state in which the impact absorber is expanded;
a first magnetic body provided on one end side of the impact absorber;
a second magnetic body provided on another end side of the impact absorber and at a position facing the first magnetic body in the folded state, wherein
one of the first magnetic body and the second magnetic body is provided so as to generate a repulsive force therebetween.

12. The impact mitigation device according to claim 11, wherein
the impact absorber includes a bellows-like structure or a structure in which tubular bodies are laterally juxtaposed.

13. The impact mitigation device according to claim 12, wherein
the impact absorber is expanded linearly.

14. The impact mitigation device according to claim 12, wherein
the impact absorber is expanded in a fan shape.

15. The impact mitigation device according to claim 11, wherein
the first magnetic body is an electromagnet including an iron core, and
the second magnetic body is a permanent magnet.

16. The impact mitigation device according to claim 11, wherein
the impact mitigation device is mounted in a vicinity of a boundary between a ceiling portion and a side wall portion of a vehicle, and in the expanded state, the impact mitigation device is expanded between an occupant and the side wall portion of the vehicle.
